(19) United States
(12) Patent Application Publication
(10) Pub. No.: US 2007/0008903 A1
(43) Pub. Date: Jan. 11, 2007

(54) Verifying liveness with fast roaming

(76) Inventors: Kapil Sood, Beaverton, OR (US); Jesse Walker, Portland, OR (US); Emily H. Qi, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/179,712

(22) Filed: Jul. 11, 2005

(51) Int. Cl. H04J 1/16

(52) U.S. Cl. 370/252; 370/352; 713/166

(57) ABSTRACT

In a re-association communications sequence between a mobile wireless device and an access point, a substantially unique may be derived and transmitted to the mobile wireless device in one of the re-association messages. The mobile wireless device may then transmit the value back to the e access point to verify that it is the same mobile wireless device.

### BACKGROUND

In various wireless networks, when a mobile station moves around it may have to “roam” from one access point (AP) to another, by establishing communication with a new AP and ending communication with the old AP. As wireless networks begin handling more and more time-critical data (such as Voice over IP and various multimedia applications), it becomes important that such transfers happen quickly to avoid interrupting the network service and to maintain acceptable quality of service. Unfortunately, this transfer also makes the communications more susceptible to various forms of attack by a rogue device that attempts to insert itself into the communications sequence during the transfer. In particular, a “replay” technique might be used by recording a valid message from a legitimate mobile device, and then replaying that message at a later time to simulate another legitimate message and gain access to the network.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of a re-associations communications sequence, according to an embodiment of the invention.

FIG. 2 shows a description of some of the contents of a data frame containing a re-association request, according to an embodiment of the invention.

FIG. 3 shows a description of some of the contents of a data frame containing a re-association response, according to an embodiment of the invention.

FIG. 4 shows a description of some of the contents of an information element (IE), according to an embodiment of the invention.

FIG. 5 shows a system, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

The term “wireless” may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The term “mobile wireless device” may be used to describe a wireless device that may be moved while it is communicating.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions stored on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include, but is not limited to, read only memory (ROM); random access memory (RAM); magnetic disk storage media; optical storage media; flash memory devices. A machine-readable medium may also include a tangible medium through which electrical, optical, acoustical or other form of propagated signals representing the instructions may pass, such as antennas, optical fibers, communications interfaces, and others.

In various embodiments, a verification value may be derived for a particular exchange of messages in a re-association sequence (the exchange of communications that establishes a new communications link between a mobile wireless device and an access point). The verification value may be transmitted by one device as part of the exchange, and repeated back by the other device to prove that the message is from a “live” device. Within the context of this document, a live device means it is the device with whom the AP believes it is communicating, rather than another device that has somehow been inserted into the communications sequence. The term “live” has been derived from the practice of trying to improperly gain access to the AP by recording a legitimate message transmitted from a mobile wireless device, and later pretending to be that device by replaying (transmitting) the recording at an opportune time. Since each re-association attempt embodied by the invention uses a different and substantially unpredictable verification value, such a recording would be detectable because it would have the wrong verification value for this communications sequence. Various forms of encryption and/or integrity checks may also be used to prevent a simple substitution of the correct verification value into the replay attempt. The transmission containing the repeated liveness verification value may be sent in a protected manner, and sent within a comparatively short period of time after the original liveness verification value was received. In this manner, tampering of the message by an unauthorized device, including any changes to the liveness verification value, may be detected. Such protection may be achieved in various ways, such as but not limited to one or more of the following: 1) calculating a message integrity code (MIC) value to perform an integrity check for the entire contents of the message (including the liveness verification value), 2) encrypting/decrypting the entire contents using a shared secret (such as one or more encryption keys), 3) both techniques, 4) other techniques.

Each new verification value may be derived in the AP, or may be derived by another device associated with the AP that provides the derived value to the AP. Various techniques may be used to derive a new verification value for each re-association attempt. Such techniques may include, but are not limited to: 1) a random number generator, 2) a pseudo-random number generator, 3) a hash value generated using an unpredictable algorithm and/or an unpredictable source, 4) etc. Regardless of the technique used, the verification value may be not only difficult to predict, but substantially unique and large enough so that duplicate values are unlikely to be generated by the same AP. Within the context of this document, “substantially unique” does not mean there is no possibility that the same value will ever again be derived for this purpose, but rather that the likelihood of the same value being derived for this purpose during a long period of operation is so unlikely that the possibility is not considered to be a concern.

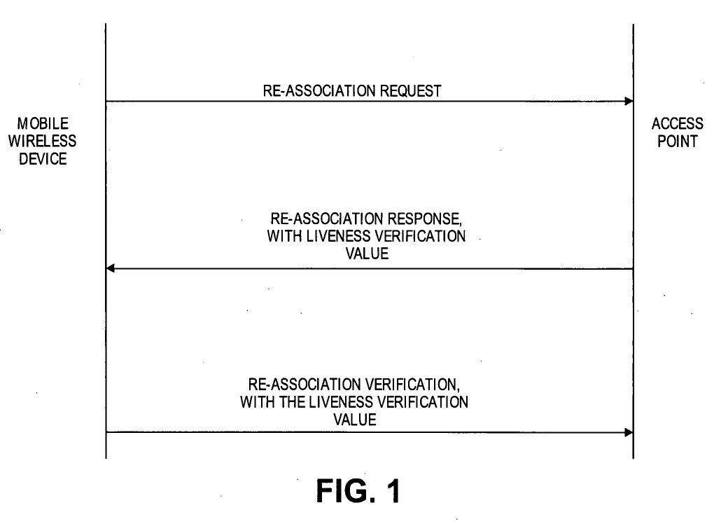

FIG. 1 shows a diagram of a re-association communications sequence, according to an embodiment of the invention. The illustrated embodiment shows a three-part handshaking sequence. Each part may be described in various terms, such as a ‘message’, but the way the terminology is used outside this document should not be interpreted as a limitation on various embodiments of the invention. Although FIG. 1 only shows communication between one AP and one mobile wireless device, in some embodiments other devices may use the channel between each of the three parts, so that the illustrated mobile wireless device and AP must re-establish who they are communicating with for each part of the three-part sequence. The functionality of each part may be encapsulated in any feasible manner for transmission, and each part may include other elements not described herein. In some embodiments, any or all of the three parts may have an associated MIC in the transmission with which to verify the integrity of the received message.

In the illustrated embodiment, the mobile wireless device may transmit a re-association request message to an access point (AP). In some operations, this request is made with the purpose of establishing communication through this new AP so that communication with the previous AP may be ended. In this manner, the mobile wireless device may continue to operate seamlessly, even thought its physical movement may bring it out of the range of one AP, and into the range of a different AP.

The AP to which the re-association request was addressed may then transmit a re-association response message to the mobile wireless device, including a liveness verification value. As previously described, the liveness verification value may be substantially unique, to avoid the likelihood that another mobile wireless device might communicate with the same AP using the same value for liveness verification. After receiving the re-association response, the mobile wireless device may then transmit a re-association verification message to the AP, including the same liveness verification value that was in the re-association response. When the AP determines that the liveness verification value in the re-association verification is the same as the liveness verification value in the re-association response, the AP may conclude that it is still communicating with the correct mobile wireless device and continue communicating with the mobile wireless device. However, if the AP determines that the liveness verification value in the re-association verification is not the same as in the re-association response, the AP may assume something improper has occurred and may terminate communications with the mobile wireless device.

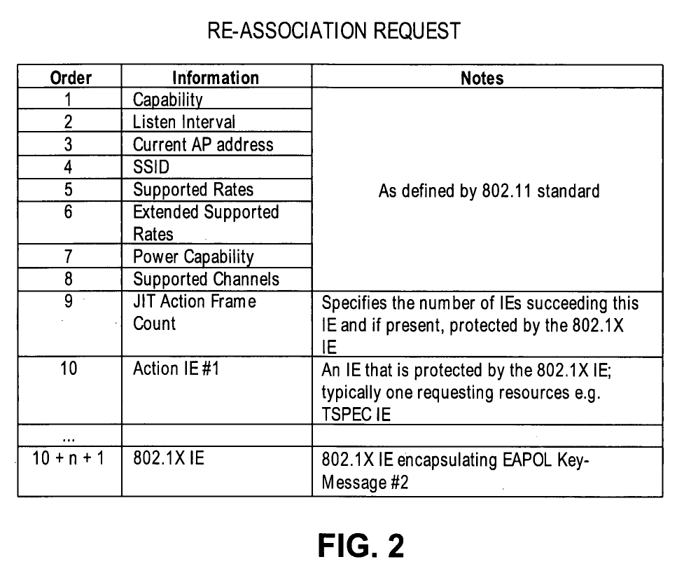

FIG. 2 shows a description of some of the contents of a data frame containing the re-association request, according to an embodiment of the invention. In some embodiments this may be a management frame. In the illustrated embodiment, the frame may include various fields, transmitted in the order shown. In some embodiments, the first eight fields shown may be as defined by various industry standards, such as one of the 802.11 standards, but other embodiments may use other techniques. Since an AP must be able to communicate with mobile wireless devices having different ranges of capabilities, these fields may allow the AP to configure the communications in a manner suitable for this particular mobile wireless device. The illustrated fields are 1) an indicator of the capability of the mobile wireless device, 2) a listening interval to be used, 3) the AP address of the AP with which the mobile wireless device has been communicating (and is presumably still communicating since full communications have not yet been established with the new AP), 4) server set identification, 5) the data rates supported by the mobile wireless device, 6) extended supported rates, 7) the power capability of the mobile wireless device, and 8) the channels supported by the mobile wireless device. The remaining fields have to do with information elements (IEs). Field 9 may indicate the number of Es that follow, while the multiple fields labeled with 10 may be those IEs. In some embodiments these Es may be as defined in the well-known 802.1X standard. In some embodiments the last IE may encapsulate the re-association request, which in particular embodiments may be a version of Message #2 of the well-known EAPOL Key (Extensible Authentication Protocol over LAN Key) four-way handshake. The EAPOL Key message may also contain an MIC value to provide integrity protection for the frame.

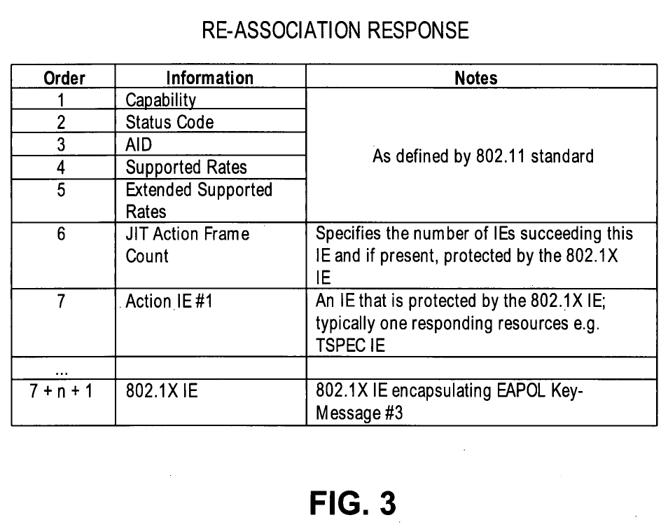

FIG. 3 shows a description of some of the contents of a data frame containing the re-association response, according to an embodiment of the invention. In some embodiments this may be a management frame. In the illustrated embodiment, the frame may include various fields, transmitted in the order shown. The first five fields shown may also be as defined by various industry standards, such as one or more of the 802.11 standards, and may further establish the parameters of communications that are to follow. The remaining fields have to do with IEs. Field 6 may indicate the number of IEs that follow, while the multiple fields labeled with 7 may be those IEs. In some embodiments the last IE may encapsulate the re-association response, which in particular embodiments may be a version of Message #3 of the EAPOL Key four-way handshake. The EAPOL Key message may also contain an MIC value to provide integrity protection for the frame.

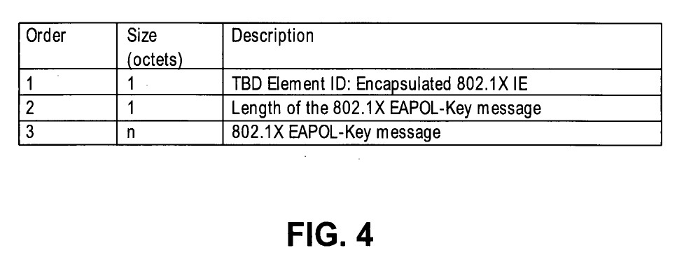

FIG. 4 shows a description of some of the contents of an information element (IE), according to an embodiment of the invention. In the illustrated embodiments the IE may contain various fields, transmitted in the order shown. The size of each field in octets is shown for this particular example, although other embodiments might use different size fields. The first field may be used for element identification. The second field may indicate the length n of the third field. The third field may contain various pieces of information. In some embodiments the third field may contain the liveness verification value in the re-association response. In some particular embodiments the liveness verification value may be contained in the EAPOL Key field of the IE.

The re-association verification message may be contained in a frame similar to that of the re-association request and the re-association response, in that it may be encapsulated in the third field of the information element described in FIG. 4 that is a part of a much larger frame, such as a management frame. But in other embodiments, re-association verification that is in an IE as described in FIG. 4 may be transmitted without being part of a management frame. In either case, the verification value in the re-association verification may be contained in the illustrated third field of the IE of FIG. 4.

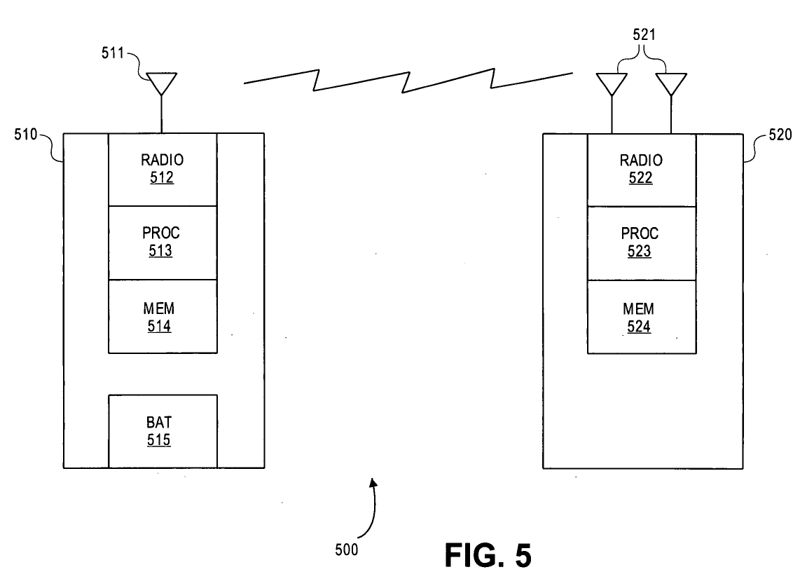

FIG. 5 shows a system, according to an embodiment of the invention. In the illustrated network 500, mobile wireless device 510 may try to establish communications with AP 520 in the manner previously described, while continuing to communicate with another AP (not shown) with which it is currently associated. The mobile wireless device 510 may comprise at least one each of antenna 511, radio 512, processor 513, memory 514, and battery 515. The antenna may be of any feasible type, such as but not limited to a dipole antenna. The memory may be of any feasible type, such as but not limited to dynamic random access (DRAM), static random access (SRAM), flash memory, etc.

The AP 520 may comprise one or more antennas 521, radio 522, processor 523, and memory 524. Antenna 521 may be of any feasible type, such as but not limited to a dipole antenna. Two or more antennas 521 may be used in any feasible manner. The memory 523 may be of any feasible type, such as but not limited to dynamic random access (DRAM), static random access (SRAM), flash memory, etc. Both mobile wireless device 510 and AP 520 may contain other elements not shown or discussed.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising a first wireless device to perform a re-association sequence with a second wireless device by:
transmitting a re-association request message to the second wireless device;
receiving, subsequent to said transmitting the re-association request message, a re-association response message from the second wireless device, the re-association response message containing a value to be used for liveness verification in the re-association sequence; and
transmitting to the second wireless device, subsequent to said receiving, a re-association verification message containing the value.

2. The apparatus of claim 1, wherein the re-association verification message is contained within a management frame.

3. The apparatus of claim 2, wherein the value is contained within an EAPOL-Key field in the management frame.

4. The apparatus of claim 1, wherein the re-association request message comprises a first message integrity code, and the re-association verification message comprises a second message integrity code.

5. The apparatus of claim 1, wherein the first wireless device comprises a battery.

6. An apparatus, comprising a first wireless device to perform a re-association sequence with a second wireless device by:
receiving a re-association request message from the second wireless device;
transmitting, subsequent to said receiving the re-association request message, a re-association response message to the second wireless device, the re-association response message containing a value to be used for liveness verification in the re-association sequence; and
receiving from the second wireless device, subsequent to said transmitting, a re-association verification message containing the value.

7. The apparatus of claim 6, wherein the re-association verification message is not contained within a management frame.

8. The apparatus of claim 6, wherein the re-association verification message is contained within a management frame.

9. The apparatus of claim 8, wherein the value is contained within an EAPOL-Key field in the management frame.

10. The apparatus of claim 6, wherein the first wireless device comprises at least two antennas.

11. A method, comprising:
transmitting a re-association request message to a wireless device;
receiving, subsequent to said transmitting the re-association request message, a re-association response message from the wireless device, the re-association response message containing a value to be used for liveness verification; and
transmitting to the wireless device, subsequent to said receiving, a re-association verification message containing the value.

12. The method of claim 11, wherein said transmitting the re-association verification message comprises transmitting the value within an EAPOL-Key field in a management frame.

13. The method of claim 11, wherein said transmitting the re-association verification message comprises transmitting the value in a management frame but not in an EAPOL-Key field.

14. A method, comprising:
receiving a re-association request message from a wireless device;
transmitting, subsequent to said receiving the re-association request message, a re-association response message to the wireless device, the re-association response message containing a value to be used for liveness verification; and
receiving from the wireless device, subsequent to said transmitting, a re-association verification message containing the value.

15. The method of claim 14, wherein said receiving the re-association verification message comprises receiving the value within an EAPOL-Key field in a management frame.

16. The method of claim 14, wherein said receiving the re-association verification message comprises receiving the value not within an EAPOL-Key field.

17. An article comprising
a machine-readable medium that provides instructions, which when executed by a computing platform, result in at least one machine performing operations comprising:
transmitting a re-association request message to a wireless device;
receiving, subsequent to said transmitting the re-association request message, a re-association response message from the wireless device, the re-association response message containing a value to be used for liveness verification; and
transmitting to the wireless device, subsequent to said receiving, a re-association verification message containing the value.

18. The article of claim 17, wherein the operation of transmitting the re-association verification message comprises an operation of transmitting the re-association verification message within a management frame.

19. The article of claim 18, wherein the operation of transmitting the re-association verification message comprises an operation of transmitting the value within an EAPOL-Key field in the management frame.

20. An article comprising
a machine-readable medium that provides instructions, which when executed by a computing platform, result in at least one machine performing operations comprising:
receiving a re-association request message from a wireless device;
transmitting, subsequent to said receiving the re-association request message, a re-association response message to the wireless device, the re-association response message containing a value to be used for liveness verification; and
receiving from the wireless device, subsequent to said transmitting, a re-association verification message containing the value.

21. The article of claim 20, wherein the operation of receiving the re-association verification message comprises an operation of receiving the re-association verification message within a management frame.

22. The article of claim 21, wherein the operation of receiving the re-association verification message comprises an operation of receiving the value within an EAPOL-Key field in the management frame.
